(19) United States
(12) Patent Application Publication
(10) Pub. No.: US 2019/0374318 A1
(43) Pub. Date: Dec. 12, 2019

(54) Method for Three-Dimensional Detection of At Least One Spatial Relationship of Two Physical Objects

(71) Applicant: a.tron3d GmbH, Klagenfurth am Woerthersee (AT)

(72) Inventor: Juergen JESENKO, Riegersdorf (AT)

(21) Appl. No.: 16/437,828

(22) Filed: Jun. 11, 2019

(30) Foreign Application Priority Data
Jun. 11, 2018 (EP) 18 177 111.4

(51) Int. Cl. A61C 9/00; A61C 13/34; A61C 19/05

(52) U.S. Cl. CPC A61C 9/0053; A61C 19/05; A61C 13/34; A61C 9/0006

(57) ABSTRACT

With a method for three-dimensional detection of at least one spatial relationship of two physical objects, in particular at least one section of an upper jaw and at least one section of a lower jaw, whereby in at least one of the objects, a physical negative impression or a physical model is available, whereby the at least one spatial relationship is digital, and the method includes the following steps: digitization of the physical negative impression or model or the physical negative impressions or models; generation of a digital model for each object of which no physical model is available; generation of at least one digital impression of at least one physical, spatial relationship of the objects, in particular a bite position of the upper jaw to the lower jaw; and deriving at least one digital, spatial relationship from the at least one digital impression.

The invention relates to a method for three-dimensional detection of at least one spatial relationship of two physical objects, in particular at least one section of an upper jaw and at least one section of a lower jaw, whereby there is a physical negative impression or a physical model for at least one of the objects.

In the 3D technology in general and the 3D dental technology in particular, there are various problems and challenges. Previously, the primary goal was to obtain as realistic a recording of objects as possible. However, now that a degree of precision in recording has been achieved that exceeds the current manufacturing capabilities, additional requirements can be solved on 3D models. One of these requirements is the interaction of various 3D models. This can be, for example, a simple meshing of gears. In dental technology, primarily the articulation of upper jaws and lower jaws is of great interest. Only when the teeth and/or dental prostheses of the upper and lower jaws correctly work together can a comfortable and healthy use of the masticatory apparatus be made possible. The negative effects in the case of incorrectly interacting jaw halves include a premature wear and tear on teeth and/or dental prostheses, and pressure on nerves and bones, which can subsequently lead to headaches and jaw pain, as well as pain in the jaw muscles.

In order to achieve as natural an interaction of teeth and dental prostheses as is possible or desirable, a physical impression of the bite—the bite registration—is taken by analog dental technology. The physical (positive) models of upper and lower jaws are then oriented accordingly to the bite registration. This is not possible in this form in digital dental technology.

Another problem arises when the transition from analog to digital dental technology is carried out. Frequently, in the course of treatment, modifications to the intraoral structures were already made, and it is no longer possible to detect the original intraoral situation digitally right in the oral cavity with a 3D scanner.

The object of the invention is therefore to overcome the above-described drawbacks.

This object is achieved according to the invention by a method with the features of claim 1.

With the method according to the invention, at least one spatial relationship of at least two physical objects is detected. The objects can be in particular an upper jaw and a lower jaw or sections thereof. For the invention to function, it is not necessary that the jaws or jaw sections be opposite one another, but from a purely practical standpoint, it can be acted under the assumption of the latter, in particular when they are only jaw sections, it can be assumed that they are opposite one another in the oral cavity and that they interact with one another in the case of biting and/or chewing movements.

According to the invention, first, at least one positive, physical model or a negative cast of one of the objects, i.e., a jaw or jaw section, is provided. It is possible that this model and/or this negative impression may have been generated at any earlier time.

All physical models and/or impressions are digitized for the method according to the invention. For this purpose, possible negative impressions can be converted ahead of time into models, for example by casting from negative impressions. It is also possible, however, to digitize the negative impressions and to convert them by computer into positive impressions.

How the computer conversion of a digitized negative impression into a digital model of the object is carried out depends on the notation of the digitized negative impression. By way of example, but not limiting, the methods for the computer conversion of digitized negative impressions, which are notated in a (T) SDF or a polygon mesh, can be roughly described as follows.

If the model is notated in a (truncated) signed distance function that is based on a voxel grid, it is sufficient to change the sign in the notation, since it is determined by sign whether a voxel of the voxel grid is located inside or outside of the surface of the digital model.

In the case of notations that consist of polygon meshes—most frequently of triangular meshes—the corner points of the polygon as well as a vector that is normal to the surface of the polygon are notated. This vector indicates which side of the polygon is located on the exterior of the notated object. An inversion of these vectors subsequently reverses the interior and exterior of the digital model and converts a negative impression into a (positive) model.

Furthermore, according to the invention, digital models are generated for all other objects about which no physical models or negative impressions are available. According to a further development of the invention this can be carried out via the intermediate step of the generation of a physical negative impression or a physical model.

In addition, a digital impression of at least one physical, spatial relationship of the objects is generated. In this respect, for example, teeth that are bitten together can be scanned.

This digital impression of the physical, spatial relationship still does not correspond in this case to a complete, digital, spatial relationship. Rather, it is to be assumed from this that during the scanning, areas of the objects that are in spatial relationship are covered by the respective other object or the respective other objects. If the objects are jaw sections or jaws, for example, the chewing surfaces and insides of the teeth are covered when the jaws bite toward one another.

In a last step, the digital models are then oriented to the digital impression of the physical, spatial relationship. As a result, a digital, spatial relationship is produced. This step can be repeated, of course, for all digital impressions of the physical, spatial relationships, if multiple such impressions were generated. This step can be automated, for example via applying the known ICP algorithm, or else can be carried out manually, for example by manual shifting of rendered, digitized models on a screen.

In addition, if two or more digital, spatial relationships were generated, a movement between these relative positions can be derived in a preferred further development of the invention. If the objects are teeth, the following is essential: the more different digital, spatial relationships are used to derive a movement, the more the derived movement corresponds to an actual chewing movement.

For the invention, it is irrelevant in which sequence the digital model and the digital impression or the digital impressions of the physical, spatial relationship are generated as long as they are available for the last step.

Also, the notation in which the digital model and impressions are stored is largely irrelevant for the invention. By way of example, but not limiting, at this point SDF, TSDF as well as most of the notations based on polygon meshes are referred to.

In another, preferred further development of the invention, all processes in which physical objects are digitized can be carried out by an equivalent scanner or the same scanner. This has the advantage that the method can be performed more economically than when, for example, a separate stationary scanner has to be made available for the digitization of the physical model.

In contrast, however, it may also be advantageous if the digitization is carried out by various, in particular different, scanners. Thus, for example, stationary desktop scanners can detect the physical model significantly more precisely than is possible with hand-operated scanners, which can also be used intraorally.

Preferably, all steps of the method can be performed at different sites; in particular, the digitization of the physical negative impression or model or the physical negative impressions or models can be carried out at a site other than the generation of a digital model of any object of which no physical model is available. Also, the generation of at least one digital impression of at least one physical, spatial relationship of the objects can be carried out at another site. Thus, for example, the objects, in particular the teeth, can be digitized at a dentist's office, while the models are stored, for example, at a dental technician's office and are also digitized there.

Analogously, it is also not necessary that the steps be carried out one right after the other. Rather, even months can elapse between the individual steps without this having a negative effect on the method provided that no basic changes to the objects themselves were performed, for example, the position of the dentition has been fundamentally changed, for example by braces.

In principle, it is stated that in terms of the invention, models are physical or digital, three-dimensional images of the objects, while physical, digital or digitized impressions and negative impressions are preliminary stages that can be processed to form models and/or digital, spatial relationships.

Additional preferred embodiments of the invention are also disclosed.

Below, a preferred embodiment of the invention is described in more detail based on the drawings. They show:

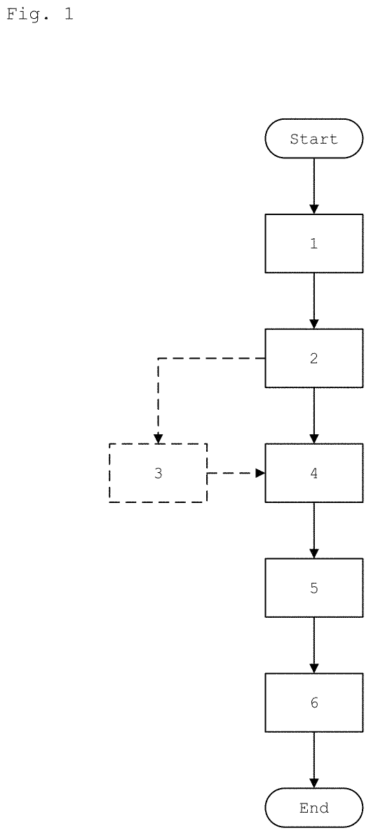

FIG. 1 shows an exemplary method according to the invention, and

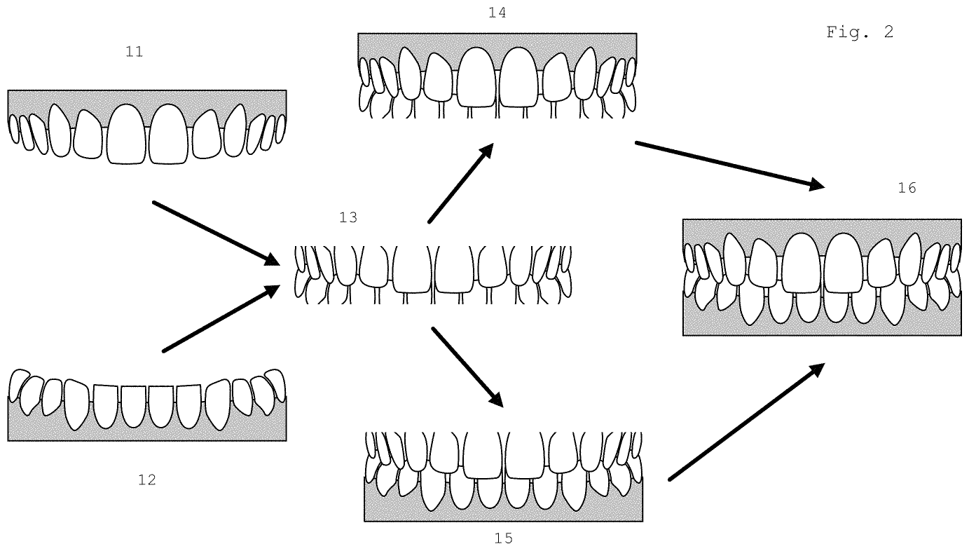

FIG. 2 shows an exemplary application of the method according to the invention.

FIG. 1 shows a flow chart of an exemplary method according to the invention. In a Step 1, first of all, a physical negative impression or a physical model of a first object is provided. The physical negative impression or the physical model of the first object from Step 1 is then digitized in Step 2, and in doing so, a digital model of the first object is generated. Next, a digital model of the second object is generated. To this end, optionally in a Step 3 first, a negative impression or a physical model of the second object can be generated. In Step 4, the second object is digitized, and in doing so, a second digital model is generated. If Step 3 is not carried out, the object itself can also be detected, for example, with a 3D scanner. In the subsequent Step 5, a digital impression of a physical, spatial relationship of the objects, in particular a bite, is generated. In Step 6, a spatial relationship of the digital model is then generated based on the digital impression.

FIG. 2 shows, heavily schematized, a practical example of the method according to the invention, in which the two digital models 11, 12 are jaws. The first digital model 11 in FIG. 2 symbolically represents an upper jaw. The second digital model 12 in FIG. 2 symbolically represents a lower jaw. In addition, FIG. 2 shows a digital impression 13 of a bite. This digital impression 13 is comparable to a (physical) bite registration, as it is used in conventional dentistry for determination of jaw relationships. Similar to a bite registration, which images only the chewing surfaces of upper and lower jaws when biting, the digital impression 13 in this case shows only a portion of the jaw, in particular a portion of the exteriors of the teeth, of the upper and lower jaws when biting, since it is not possible for a 3D scanner to detect the chewing surfaces or interiors (lingual sides) of the teeth during biting.

In the practical example of the invention shown in FIG. 2, therefore, first of all, the first digital model 11 is registered with the digital impression 13 to form a first intermediate registration 14 in order to determine the correct jaw relationship together with complete models of the upper and lower jaws. Of course, a method according to the invention can also be performed with incomplete models. Then, the second digital model 12 with the digital impression 13 is registered in a second intermediate registration 15. Since, with two intermediate registrations 14, 15, the spatial relationship of the first and second digital models 11, 12 to the digital impression 13 is known, the spatial ratio of the first and second digital models 11, 12 to one another is also known indirectly. In a final step, the two intermediate registrations 14, 15 can be assembled to form a final data set 16. The final data set 16 that is assembled then contains the geometric information on the upper and lower jaws as well as a jaw correlation corresponding to the bite.

If the digital surfaces are depicted as SDF or TSDF, as is the case in the depicted example, the registrations can be notated as simple translation matrices, which consist each of the combination of a translation vector with a rotational matrix.

The intermediate registrations 14, 15, shown in FIG. 2, in this case are used only for illustration. It is neither necessary to combine the entire first and second digital models with the digital impression 13 nor to carry out the combination with the digital impression 13 completely. It is sufficient for only a corresponding translation matrix (consisting of a translation vector and a rotational matrix) to be stored in the respective model. The two translation matrices can then be joined with a simple geometric operation so that upper and lower jaws can be correctly positioned with respect to one another in a new 3D model.

### CONTENT OF THE FIGURES

### FIG. 1

1 Physical model of the first object is made available

2 Physical model from 1 is digitized and in this case generates a first, digital model

3 (Optional) physical model of the second object is generated

4 Second object is digitized and in this case generates a second, digital model

5 Digital impression of a bite is generated

6 A spatial relationship of the digital model is generated based on the digital impression.

11 First digital model (upper jaw)

12 Second digital model (lower jaw)

13 Digital impression of a bite

14 First intermediate step

15 Second intermediate step

16 Spatial relationship of the digital model (upper jaw, lower jaw, and jaw correlation)

1. Method for three-dimensional detection of at least one spatial relationship of two physical objects, in particular at least one section of an upper jaw and at least one section of a lower jaw, whereby of at least one of the objects, a physical negative impression or a physical model is available, wherein the at least one spatial relationship is digital, and wherein the method comprises the following steps:
digitizing the physical negative
impression or physical model or the physical negative impressions or physical models,
generating a digital model for each object of which no physical model is available,
generating at least one digital impression of at least one physical, spatial relationship of the objects, in particular a bite position of the upper jaw to the lower jaw, and
deriving at least one digital, spatial relationship from the at least one digital impression.

2. Method according to claim 1, wherein two or more digital, spatial relationships are detected and wherein a movement between the digital, spatial relationships is reconstructed.

3. Method according to claim 1, wherein the digital models are automatically brought into relation with the digital impression.

4. Method according to claim 1, wherein the digital models are manually brought into relation with the digital impression.

5. Method according to claim 1, wherein the digitization is carried out by an equivalent scanner or the same scanner.

6. Method according to claim 1, wherein the digitization is carried out by various, in particular different, scanners.

7. Method according to claim 1, wherein the digitization of the physical negative impression or physical model or of the physical negative impressions or physical models is carried out at a site other than that of the generation of a digital model of any object of which no physical model is available and respectively the generation of at least one digital impression of at least one physical, spatial relationship of the objects.

8. Method according to claim 2, wherein the digital models are automatically brought into relation with the digital impression.

9. Method according to claim 2, wherein the digitization is carried out by an equivalent scanner or the same scanner.

10. Method according to claim 3, wherein the digitization is carried out by an equivalent scanner or the same scanner.

11. Method according to claim 4, wherein the digitization is carried out by an equivalent scanner or the same scanner.

12. Method according to claim 2, wherein the digitization is carried out by various, in particular different, scanners.

13. Method according to claim 3, wherein the digitization is carried out by various, in particular different, scanners.

14. Method according to claim 4, wherein the digitization is carried out by various, in particular different, scanners.

15. Method according to claim 2, wherein the digitization of the physical negative impression or physical model or of the physical negative impressions or physical models is carried out at a site other than that of the generation of a digital model of any object of which no physical model is available and respectively the generation of at least one digital impression of at least one physical, spatial relationship of the objects.

16. Method according to claim 3, wherein the digitization of the physical negative impression or physical model or of the physical negative impressions or physical models is carried out at a site other than that of the generation of a digital model of any object of which no physical model is available and respectively the generation of at least one digital impression of at least one physical, spatial relationship of the objects.

17. Method according to claim 4, wherein the digitization of the physical negative impression or physical model or of the physical negative impressions or physical models is carried out at a site other than that of the generation of a digital model of any object of which no physical model is available and respectively the generation of at least one digital impression of at least one physical, spatial relationship of the objects.

18. Method according to claim 5, wherein the digitization of the physical negative impression or physical model or of the physical negative impressions or physical models is carried out at a site other than that of the generation of a digital model of any object of which no physical model is available and respectively the generation of at least one digital impression of at least one physical, spatial relationship of the objects.

19. Method according to claim 6, wherein the digitization of the physical negative impression or physical model or of the physical negative impressions or physical models is carried out at a site other than that of the generation of a digital model of any object of which no physical model is available and respectively the generation of at least one digital impression of at least one physical, spatial relationship of the objects.

20. Method according to claim 8, wherein the digitization of the physical negative impression or physical model or of the physical negative impressions or physical models is carried out at a site other than that of the generation of a digital model of any object of which no physical model is available and respectively the generation of at least one digital impression of at least one physical, spatial relationship of the objects.
